(19) United States
(12) Patent Application Publication
(10) Pub. No.: US 2014/0158945 A1
(43) Pub. Date: Jun. 12, 2014

(54) Methods of Increasing the Thermoelectric Performance of a Material

(71) Applicant: Evident Technologies, Troy, NY (US)

(72) Inventors: Clinton T. Ballinger, Burnt Hills, NY (US); Adam Z. Peng, Schenectady, NY (US); Susanthri Perera, Cohoes, NY (US)

(73) Assignee: Evident Technologies, Troy, NY (US)

(21) Appl. No.: 14/094,276

(22) Filed: Dec. 2, 2013

Related U.S. Application Data
(60) Provisional application No. 61/731,876, filed on Nov. 30, 2012.

(51) Int. Cl. B29B 13/08

(52) U.S. Cl. CPC B29B 13/08
USPC 252/500; 264/460

(57) ABSTRACT

Embodiments of the invention relate generally to increasing the thermoelectric performance of a material. In one embodiment, the invention provides a method of improving the thermoelectric performance of a material, the method comprising: obtaining a powdered semiconductor material; and applying a current to the powdered semiconductor material

### CROSS-REFERENCE TO RELATED APPLICATIONS

This application claims the benefit of co-pending U.S. Provisional Application Ser. No. 61/731,876, filed 30 Nov. 2012, which is hereby incorporated by reference herein.

### FIELD OF THE INVENTION

Embodiments of the present invention relate generally to methods of increasing the thermoelectric performance of a material by enhancing the electron transport properties of a consolidated material.

### BACKGROUND OF THE INVENTION

The goal of many materials researchers interested in thermoelectric applications is to improve the overall performance of the material. Traditionally, this is done by carefully trying to maximize the thermoelectric figure of merit of the particular material. There is traditionally a tradeoff between the desire for good electrical conductivity and the desire for poor thermal conductivity. These properties are usually dependent to some extent upon one another, and are thus difficult to alter individually.

The Seebeck coefficient of the material is also very important for thermoelectric applications. Many researchers try to alter this coefficient by control of the stoichiometry, grain size, and other related parameters of a material. Recently, researchers have used finely milled powder in an attempt to enhance the Seebeck coefficient and to reduce the thermal conductivity.

The powders of specific semiconductor materials have been consolidated together to form a material that has good thermoelectric performance in the consolidated form. Hot pressing and spark plasma sintering (SPS) are two of the methods that are used to consolidate such semiconductor powders into a final workable solid that can be used in thermoelectric applications. Both of these methods rely on heat and pressure to consolidate the material and it is well known that this will also cause grain growth.

Typically small particles (e.g., nanometer or micrometer sized materials) tend to agglomerate and grow as the temperature increases. However, this growth is traditionally seen as necessary if one is to take a powder and create a solid material with good mechanical properties.

The goal of many researchers is to maintain very small sizes of grains to get a benefit to the thermoelectric figure of merit but the traditional consolidation processes will result in increasing the grain size.

### SUMMARY OF THE INVENTION

A first aspect of the present invention includes a method of improving the thermoelectric performance of a material, the method comprising: obtaining a powdered semiconductor material; and applying a current to the powdered semiconductor material.

A second aspect of the present invention includes a method of improving the thermoelectric performance of a material, the method comprising: adding a powdered semiconductor material to a die; cold pressing the powdered semiconductor material; and releasing the cold-pressed semiconductor material from the die.

A third aspect of the present invention includes a material made by a method comprising: obtaining a powdered semiconductor material; and applying a current to the powdered semiconductor material.

A fourth aspect of the present invention includes a material made by the method comprising: adding a powdered semiconductor material to a die; cold pressing the powdered semiconductor material; and releasing the cold-pressed semiconductor material from the die.

### DETAILED DESCRIPTION OF THE INVENTION

Embodiments of the invention include a methodology where the final consolidated material can be mechanically stable enough for thermoelectric applications while retaining the properties desired, such as small grain sizes.

Reducing the consolidation temperature and/or hold time at the consolidation temperature can reduce the grain growth of the material; however this is often at the expense of the mechanical strength of the resulting material. In one embodiment, the first step in consolidation may be to use a high current (such as greater than approximately 1 Amp), low voltage (such as less than approximately 10V) power supply applied through the material. In some embodiments, the power supply may be provided by such techniques as arc welding or spark plasma sintering. As the current passes through the powder, it will choose a path that is of least resistance. In such an embodiment, a low voltage path will inherently be chosen. When the current is applied for a certain amount of time, in some cases fractions of a second and up to approximately 30 minutes, the material will melt or sinter, due to resistive heating, along the path taken by electrical current. This process can develop nanostructured pathways through the material along the current path. These pathways can allow for increased electron transport ability, thus making the material a more effective thermoelectric material.

In some embodiments, a powder can be cold pressed with little or no heat to consolidate the material. The pressure used to consolidate the powder must be high enough to make a solid pellet that is structurally stable enough to be released from the die without cracking. This can typically be accomplished with pressures in excess of about 40 MPa. When a powder is cold pressed, some embodiments will include passing a current through the resulting cold pressed material as described above.

In some embodiments, the pressed material could still be hot pressed or go through Spark Plasma Sintering techniques. However, the material may be put through these processes for a shorter period of time than typical of traditional methods, and these more traditional methods could be in conjunction with the processes described herein. A typical hold time for hot pressing or SPS may be 5 minutes or greater, while embodiments such as this may only require hold times of about half of this amount or less. For example, a cold pressed powder can be made into a pellet using a die in the cold press, and then the pellet can be placed between the rams of an SPS machine with or without a die and current can be passed through the pellet to enhance the electrical properties and increase the mechanical strength.

In another embodiment, a method of making a material includes mixing the appropriate nanosized semiconductors together as a dry powder. The above disclosed powders may include core or core/shell semiconductor nanocrystals, with or without a matrix material incorporated in the powder. The final material may be stratified into different types of layers, for instance, by using the described powder and incorporating it into layers which contain variations in grain size, composition of material, amount or types of dopant, and other similar variations. For example, one embodiment may include mixing 20 nm nanocrystals with a ball-milled nano-powder that has a large size distribution with sizes ranging from about 20 nm to about 2000 nm. One method of using the dry powder includes consolidating the material. Another similar embodiment could accomplish nanostructured paths as disclosed above, except metallic or insulating nanoparticles, examples of which may include nanosized gold, copper, zinc or other metals while insulators may be made of nano-oxides, high bandgap nano semicondcutors like nano-Si, carbon, or other nano-ceramic materials, may be utilized, either alone or in conjunction with the above disclosed materials, in order to accomplish the desired electronic effect in the resulting material.

Although described as separate embodiments, each of the disclosed methods may be used in some combination. For instance, a material may be cold pressed prior to application of a high voltage low current, or a material that has current applied may be further sintered via traditional techniques for a shorter period. The order and combination of processes described should not be considered limiting, as any combination is possible.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of improving the thermoelectric performance of a material, the method comprising:
obtaining a powdered semiconductor material; and
applying a current to the powdered semiconductor material.

2. The method of claim 1, wherein the current is greater than approximately 1 Amp.

3. The method of claim 2, wherein the current has a voltage of less than approximately 10V.

4. The method of claim 1, further comprising:
applying at least one of hot pressing or spark plasma sintering (SPS) techniques prior to applying the current.

5. The method of claim 1, further comprising:
applying at least one of hot pressing or spark plasma sintering (SPS) techniques after applying the current.

6. The method of claim 1, further comprising:
cold pressing the powder prior to the applying a current.

7. The method of claim 6, further comprising:
applying at least one of hot pressing or spark plasma sintering (SPS) techniques after applying the current.

8. A method of improving the thermoelectric performance of a material, the method comprising:
adding a powdered semiconductor material to a die;
cold pressing the powdered semiconductor material; and
releasing the cold-pressed semiconductor material from the die.

9. The method of claim 8, wherein the cold pressing includes applying to the powdered semiconductor material a pressure in excess of about 40 MPa.

10. The method of claim 8, further comprising:
applying a current to the powdered semiconductor material.

11. The method of claim 10, wherein the current is greater than approximately 1 Amp.

12. The method of claim 10, wherein the current has a voltage of less than approximately 10V.

13. The method of claim 8, further comprising:
applying a current to the cold-pressed semiconductor material.

14. The method of claim 13, wherein the current is greater than approximately 1 Amp.

15. The method of claim 13, wherein the current has a voltage of less than approximately 10V.

16. A material made by a method comprising:
obtaining a powdered semiconductor material; and
applying a current to the powdered semiconductor material.

17. A material made by the method comprising:
adding a powdered semiconductor material to a die;
cold pressing the powdered semiconductor material; and
releasing the cold-pressed semiconductor material from the die.
